(19) United States
(12) Patent Application Publication
(10) Pub. No.: US 2020/0057533 A1
(43) Pub. Date: Feb. 20, 2020

(54) TOTALING SYSTEM, TERMINAL SYSTEM, SERVER, RECORDING MEDIUM, AND TOTALING METHOD

(71) Applicant: SHARP KABUSHIKI KAISHA, Sakai City, Osaka (JP)

(72) Inventors: TORU UEDA, Sakai City, Osaka (JP); KIYOSHI SUZUKI, Sakai City, Osaka (JP); MINORU WADAYAMA, Sakai City, Osaka (JP); KIYOFUMI OHTSUKA, Sakai City, Osaka (JP)

(73) Assignee: SHARP KABUSHIKI KAISHA, Sakai City, Osaka (JP)

(21) Appl. No.: 16/609,191

(22) PCT Filed: Jul. 6, 2018
(86) PCT No.: PCT/JP2018/025695

§ 371 Date: Oct. 28, 2019

(30) Foreign Application Priority Data
Aug. 10, 2017 (JP) 2017-155905

(51) Int. Cl. G06F 3/0481; G06F 3/01

(52) U.S. Cl. CPC G06F 3/0481; G06F 3/016; G06F 3/011; G06F 3/017

(57) ABSTRACT

The present invention enables making a response that (i) increases a user's motivation to cheer for an event and (ii) motivates the user to visit an event site to cheer. A totalizing system (100) includes a server (3) and a terminal system (10). In a specific mode, the terminal system (i) detects a user's behavior including motion and utterance, (ii) transmits a cheering point calculated with reference to the behavior which has been detected, and (iii) displays a result of totalization obtained. The server makes a totalization of a cheering point obtained and transmits a result of the totalization.

### TECHNICAL FIELD

The present invention relates to a totalizing system, a terminal system, server, a program, and a totalizing method.

### BACKGROUND ART

Research and development has been conducted on an electronic device which (i) estimates an emotional state of a user on the basis of a facial expression and the like of the user and (ii) outputs an image, a voice message, and the like as an appropriate response to the emotional state which has been estimated. For example, Patent Literature 1 discloses an electronic device which includes (i) a user state analyzing section which analyzes a state of a user, (ii) a content information analyzing section which analyzes a state of content, (iii) a comment generating section which prepares, on the basis of the state of the user and the state of the content which have been analyzed, a comment with which the user will presumably feel empathy, and (iv) a comment output section which outputs, with use of a voice or the like, the comment which has been prepared.

### CITATION LIST

### Patent Literature

[Patent Literature 1]

Japanese Patent Application Publication, Tokukai, No. 2016-186741 (Publication date: Oct. 27, 2016)

### SUMMARY OF INVENTION

### Technical Problem

However, examples of the state of the user, which state is detected by the electronic device of Patent Literature 1 and is to be analyzed by the user state analyzing section, include a facial expression, a voice, a pulse, and the like of the user, but not a motion of a body of the user. Accordingly, for example, in a case where the user is watching a sport in a stadium, or in a case where the user is participating in a radio calisthenics event (“radio calisthenics” refers to warm-up calisthenics popular in Japan, performed to music and guidance from radio broadcasts), a trekking tour, a music event, or the like, or in the like cases, the electronic device cannot make an appropriate response which is in accordance with the number, extent, etc. of the user's cheering motions. This prevents the electronic device from increasing the user's motivation to cheer for an event and from motivating the user to visit a stadium or the like to cheer.

An aspect of the present invention is accomplished in view of the problem. An object of the present invention is to enable making a response that (i) increases a user's motivation to cheer for an event and (ii) motivates the user to visit an event site or the like to cheer.

### Solution to Problem

In order to attain the object, a totalizing system in accordance with an aspect of the present invention is a totalizing system, including: one or more servers; and one or more terminal systems, each of the one or more terminal systems including: a terminal communication section; a terminal control section; an information presenting section; and a behavior detecting section, the behavior detecting section being configured to detect a behavior of a user, the behavior including at least one of motion and utterance, the terminal control section being configured to: determine which one of a plurality of modes is currently set; calculate a cheering point with reference to behavior data in a case where the terminal control section has determined that a specific mode is currently set, the behavior data being indicative of the behavior detected by the behavior detecting section; transmit, via the terminal communication section, the cheering point which has been calculated; and cause the information presenting section to present totalization information obtained via the terminal communication section, the totalization information being indicative of a total of a cheering point, each of the one or more servers including: a server communication section; and a server control section, the server control section being configured to: make a totalization of a cheering point obtained via the server communication section; and transmit, via the server communication section, totalization information indicative of a result of the totalization.

In order to attain the object, a terminal system in accordance with an aspect of the present invention is a terminal system which communicates with one or more servers, including: a terminal communication section; terminal control section; an information presenting section; and a behavior detecting section, the behavior detecting section being configured to detect a behavior of a user, the behavior including at least one of motion and utterance, the terminal control section being configured to: determine which one of a plurality of modes is currently set; calculate a cheering point with reference to behavior data in a case where the terminal control section has determined that a specific mode is currently set, the behavior data being indicative of the behavior detected by the behavior detecting section; transmit, via the terminal communication section, the cheering point which has been obtained; and cause the information presenting section to present totalization information obtained via the terminal communication section.

In order to attain the object, a server in accordance with an aspect of the present invention is a server which communicates with one or more terminal systems, including: a server communication section; and a server control section, the server control section being configured to: make a totalization of a cheering point obtained from the one or more terminal systems via the server communication section; and transmit, to the one or more terminal systems via the server communication section, totalization information indicative of a result of the totalization.

In order to attain the object, a program in accordance with an aspect of the present invention is a program for causing a computer to function as a terminal device, the program causing the computer to: determine which one of a plurality of modes is currently set; and calculate a cheering point with reference to behavior data in a case where the computer has determined that a specific mode is currently set, the behavior data being indicative of a behavior which has been detected.

In order to attain the object, a program in accordance with an aspect of the present invention is a totalizing method carried out by a totalizing system, said totalizing system including: one or more servers; and one or more terminal systems, said totalizing method comprising the steps of: (a) the one or more terminal systems detecting a behavior of a user, the behavior including at least one of motion and utterance; (b) the one or more terminal systems determining which one of a plurality of modes is currently set; (c) the one or more terminal systems calculating a cheering point with reference to behavior data in a case where the one or more terminal systems have determined that a specific mode is currently set, the behavior data being indicative of the behavior which has been detected; (d) the one or more terminal systems transmitting the cheering point which has been calculated; (e) the one or more terminal systems presenting totalization information which has been obtained, the totalization information being indicative of a total of a cheering point; (f) the one or more servers making a totalization of a cheering point obtained via the server communication section; and (g) the one or more servers transmitting totalization information indicative of a result of the totalization.

### Advantageous Effects of Invention

According to one aspect of the present invention, it is possible to make a response that (i) increases a user's motivation to cheer for an event and (ii) motivates the user to visit an event site or the like to cheer.

### BRIEF DESCRIPTION OF DRAWINGS

FIG. 1 is a view illustrating a configuration of a totalizing system in accordance with Embodiment 1 of the present invention.

FIG. 2 is views illustrating an appearance of a first terminal in accordance with Embodiment 1 of the present invention.

FIG. 3 is views illustrating an operation carried out on a screen of a second terminal in order to establish pairing with the first terminal, in accordance with Embodiment 1 of the present invention.

FIG. 4 is views illustrating an operation carried out on a screen of the second terminal in order to change a setting of a bodily sensation notification section, lights, or the like of the first terminal, in accordance with Embodiment 1 of the present invention.

FIG. 5 is views illustrating an operation carried out on a screen of the second terminal in order to change a setting of notification information to be notified to the first terminal, in accordance with Embodiment 1 of the present invention.

FIG. 6 is views illustrating an example of a state of a baseball game displayed on a display section of the first terminal, in accordance with Embodiment 1 of the present invention.

FIG. 7 is views illustrating operation screens of the second terminal, which operation screens are related to voting for a player with use of a cheering point, in accordance with Embodiment 1 of the present invention.

FIG. 8 is views illustrating screens related to a watching mode, in accordance with Embodiment 1 of the present invention.

FIG. 9 is a table illustrating information transmitted between a terminal systems and a server in accordance with a watching mode, in accordance with Embodiment 1 of the present invention.

FIG. 10 is a sequence chart illustrating a process which is related to game progress information and carried out b the totalizing system in accordance with Embodiment 1 of the present invention.

FIG. 11 is a sequence chart illustrating a process which is related to totalization of points and carried out by the totalizing system in accordance with Embodiment 1 of the present invention.

FIG. 12 is a sequence chart illustrating a process which is related to totalization of voting points and carried out by the totalizing system in accordance with Embodiment 1 of the present invention.

FIG. 13 is a sequence chart illustrating a process which is related to event progress information and carried out by a totalizing system in accordance with. Embodiment 2 of the present invention.

FIG. 14 is a block diagram illustrating an example configuration of a computer that can be used as a terminal system and a server in accordance with Embodiment 4 of the present invention.

### DESCRIPTION OF EMBODIMENTS

### Embodiment 1

The following description will discuss in detail Embodiment 1 of the present invention.

Configuration of Totalizing System 100

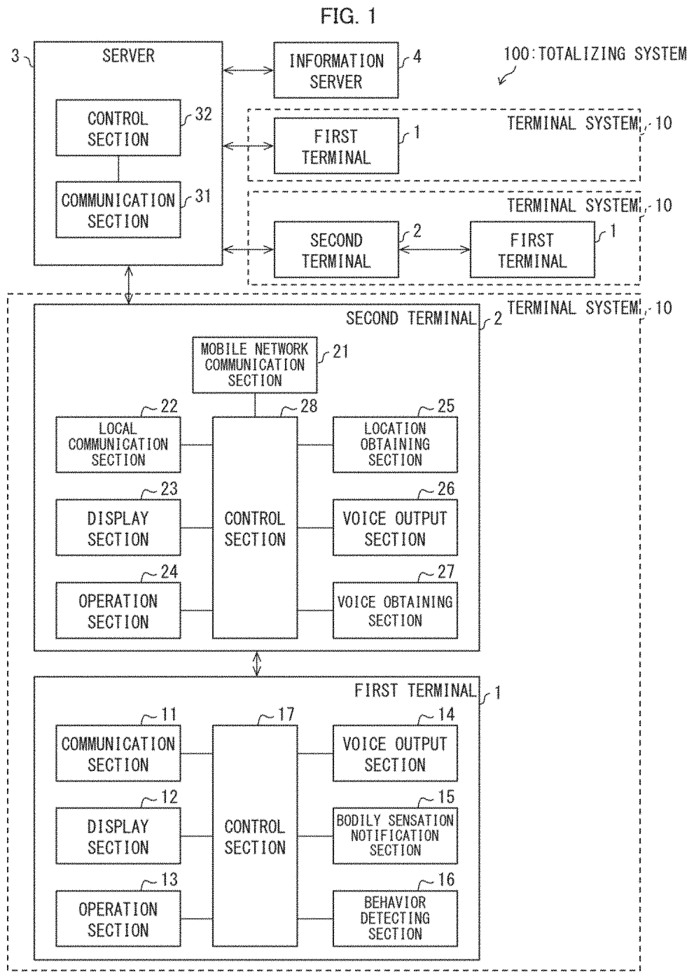

FIG. 1 is a view illustrating a configuration of a totalizing system 100 in accordance with Embodiment 1. The totalizing system 100 includes (i) one or more servers, namely, a server (first server) 3 and an information server (second server) 4 and (ii) one or more terminal systems 10.

Configuration of Terminal System 10

Each of the one or more terminal systems 10 includes mobile network communication section (terminal communication section) 21, (ii) a control section (terminal control section) 28, (iii) a display section (information presenting section) 12, and (iv) a behavior detecting section 16.

The each of the one or more terminal systems 10 includes a first terminal (first terminal device) 1 and a second terminal (second terminal device) 2. Note that any one of the one or more terminal systems 10 may include only the first terminal (a single terminal device) 1.

Configuration of First Terminal 1

The first terminal 1 is a wearable terminal exemplified by a watch-type terminal or the like. As illustrated in FIG. 1, the first terminal 1 includes (i) a communication section (first terminal communication section) 11, (ii) the display section (information presenting section, first information presenting section) 12, (iii) an operation section 13, (iv) a voice output section 14, (v) a bodily sensation notification section 15, (vi) the behavior detecting section 16, and (vii) a control section (terminal control section, first terminal control section) 17.

The communication section 11 communicates with the second terminal 2 or the server 3. A communication between the first terminal 1 and the second terminal 2 is not limited to a specific one. Examples of the communication include communications via Bluetooth (registered trademark), Wi-Fi (registered trademark), 5G, and other communications. The display unit 12 is a display or the like which displays a state of a game and the like. The operation section 13 receives an operation carried out by a user, and is exemplified by a button or the like. The display section 12 and the operation section 13 may be provided integrally as a touch panel. The voice output section 14 outputs a voice and is exemplified by a speaker or the like.

The bodily sensation notification section 15 is exemplified by a vibrator or the like which notifies information by causing the first terminal 1 to vibrate. The bodily sensation notification section 15 may be, for example, (i) a force feedback device or the like which makes a notification of information by giving a sense of force or (ii) a tactile feedback device or the like which makes a notification of information by giving a sense of touch. The behavior detecting section 16 detects a user's behavior including at least one of motion and utterance. The behavior detecting section 16 may be a motion sensor which detects a motion of a user, or may be a microphone which detects an utterance of a user or a sound made by a user (by clapping, stepping, or the like). The control section 17 controls the entire first terminal 1.

The control section 17 obtains game progress information (event progress information) from the second terminal 2 via the communication section 11, and causes the display section 12 to display the game progress information thus obtained.

Further, the control section 17 determines which one of a plurality of modes is currently set. In a case where the control section 17 has determined that a specific mode is currently set, the control section 17 (i) calculates a cheering point with reference to behavior data indicative of a behavior detected by the behavior detecting section 16, (ii) transmits, via the communication section 11, the cheering point thus calculated, and (iii) causes the display section 12 to display totalization information indicative of a total of cheering points and has been obtained via the communication section 11. The control section 17 makes, in accordance with a mode which is currently set, a notification (a bodily sensation feedback) with use of a bodily sensation, for example, by causing the bodily sensation notification section 15 to vibrate.

Note that a “cheering point” refers to digital information simply abstracted from a behavior of a user, and is not concerned with whether or not the user intends to cheer. A cheering point may be, for example, digital information abstracted from a behavior of a user who has performed radio calisthenics during a radio calisthenics event.

The control section 17 obtains totalization information from the second terminal 2 via the communication section 11, and causes the display section 12 to display the totalization information thus obtained.

Note that in the above-mentioned case in which any one of the one or more terminal systems 10 includes only the first terminal 1, the first terminal 1 may include the mobile network communication section 21, a location obtaining section 25, and a voice obtaining section 27 (each described later), or may include no communication section 11.

Note that although Embodiment 1 deals with an example case in which a notification is made on a state of a “game”, the present invention is applicable not only to “games” but also to “events” in general, examples of which include a concert and the like. Further, “event progress information” recited in the claims is a superordinate concept encompassing the “game progress information”.

Configuration of Second Terminal 2

The second terminal 2 is a mobile terminal exemplified by a smartphone or the like. As illustrated in FIG. 1, the second terminal 2 includes (i) the mobile network communication section (terminal communication section) 21, (ii) a local communication section (second terminal communication section) 22, (iii) a display section 23, (iv) an operation section 24, (v) the location obtaining section 25, (vi) a voice output section 26, (vii) the voice obtaining section 27, and (vii) the control section (terminal control section, second terminal control section) 28.

The mobile network communication section 21 communicates with the server 3. The local communication section 22 communicates with the first terminal 1. The display unit 23 is a display or the like which displays various information. The operation section 24 receives an operation carried out by a user, and is exemplified by a button or the like. The display section 23 and the operation section 24 may be provided integrally as a touch panel. The location obtaining section 25 obtains location information of the second terminal 2. The location obtaining section 25 may obtain the location information by a global positioning system (GPS) function or by other methods (e.g., a method in which reception is performed with use of an SSID of a smartphone, or the like method). The voice output section 26 is a speaker or the like which outputs a voice. The voice obtaining section 27 is a microphone or the like which obtains a voice. The control section 28 controls the entire second terminal 2.

The control section 28 obtains totalization information from the server 3 via the mobile network communication section 21, and transmits the totalization information thus obtained to the first terminal 1 via the local communication section 22.

Further, the control section 28 (i) obtains vote information indicative of a number provided by a user as a vote, (ii) transmits, via the mobile network communication section 21, the vote information thus obtained, and (iii) causes the display section 23 to display a result of totalization of numbers given as votes, which result has been obtained via the mobile network communication section 21.

Configuration of Server 3

The server 3 is a server providing a cloud service. The server 3 processes information obtained from the information server 4 and transmits the information thus processed to the one or more terminal systems 10.

As illustrated in FIG. 1, the server 3 includes a communication section (server communication section) 31 and a control section (server control section) 32. The communication section 31 communicates with the first terminal 1, the second terminal 2, and the information server 4. The control section 32 controls the entire server 3.

The control section 32 carries out totalization of cheering points obtained via the communication section 31, and transmits, via the communication section 31, totalization information indicative of a result of the totalization.

Further, the control section 32 (i) extracts, from game information obtained via the communication section 31, game progress information related to a specific game and (ii) transmits, via the communication section 31, the game progress information thus extracted.

Further, the control section 32 carries out totalization of vote information obtained via the communication section 31, and transmits, via the communication section 31, vote totalization information indicative of a result of the totalization.

The information server 4 is a server providing various information to the server 3.

Appearance of First Terminal 1

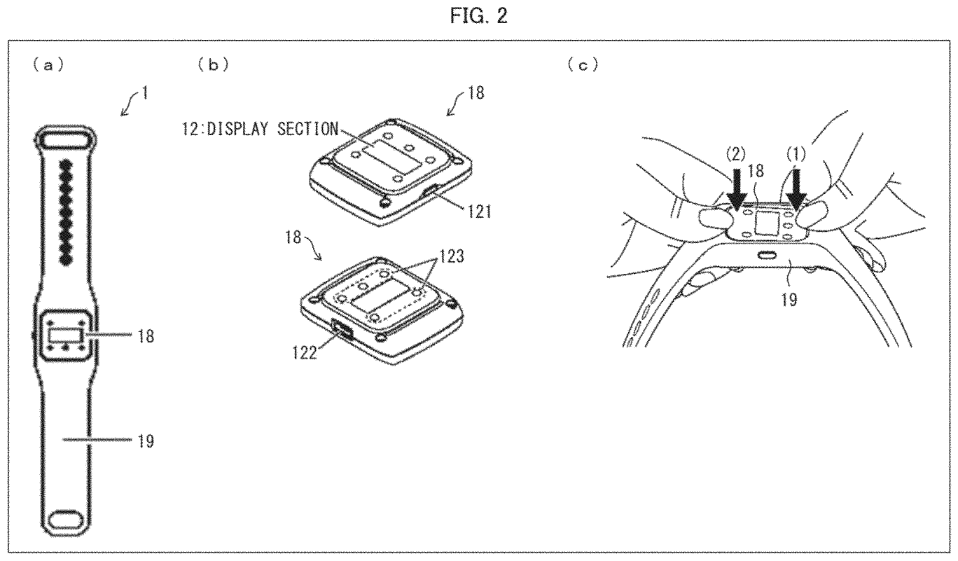

FIG. 2 is views illustrating an appearance of the first terminal 1 in accordance with Embodiment 1. (a) of FIG. 2 illustrates the entire first terminal 1. (b) of FIG. 2 illustrates an appearance of a core 18 of the first terminal 1. (c) of FIG. 2 illustrates attachment and detachment of the core 18 to and from a band 19.

As illustrated in (a) of FIG. 2, the first terminal 1 includes the core 18 and the band 19. The core 18 is a main body of the first terminal 1. The band 19 is a portion of the first terminal 1 which portion allows the first terminal 1 to be attached to a wrist of a user.

As illustrated in (b) of FIG. 2, the core 18 includes the display section 12, a power button 121, a charging terminal 122, and lights 123. The display section 12 is a display which displays various information. The power button 121 is a button for turning on and off the core 18. The charging terminal 122 is a terminal which is provided to charge the core 18 and to which a power cable plugged in an electrical outlet is connected. The lights 123 are individually turned on.

As illustrated in (c) of FIG. 2, the user can detach the core 18 from the band 19 by pressing the band 19 at portions surrounding the core 18, in the order of (1)->(2).

Note that the core 18 does not necessarily have to be detachable from the band 19. The core 18 and the band 19 may be integrally provided. The band 19 may have a part or all of functions of the core 18.

Example of Operation Screen Displayed

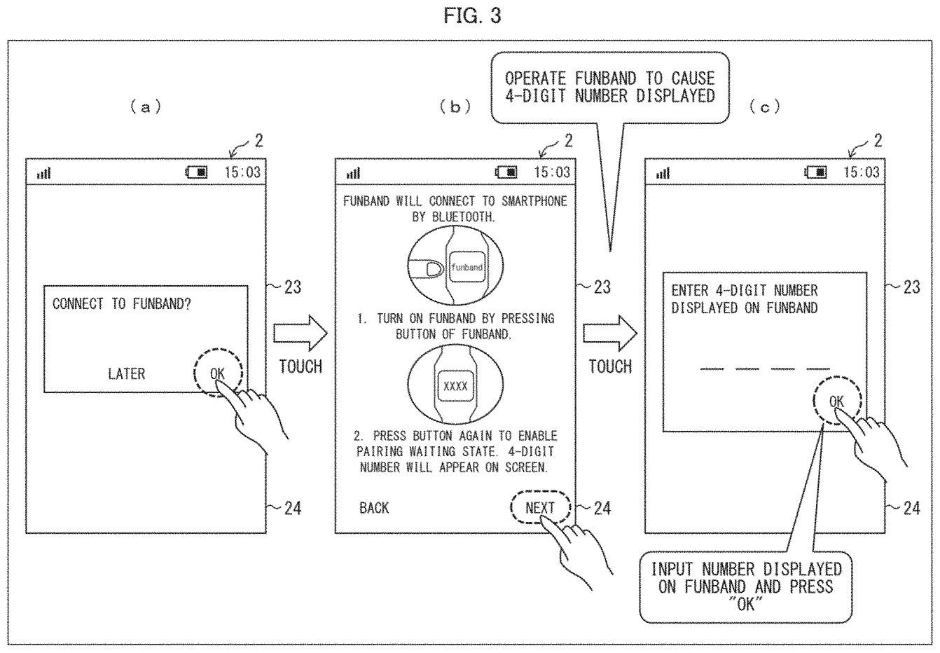

FIG. 3 is views illustrating an operation carried out on a screen of the second terminal 2 in order to establish pairing with the first terminal 1, in accordance with Embodiment 1. (a) of FIG. 3 illustrates a screen which inquires whether or not to connect to the first terminal 1. (b) of FIG. 3 illustrates a screen of the second terminal 2 which screen explains a procedure for establishing pairing with the first terminal 1. (c) of FIG. 3 illustrates a screen for inputting a number.

As illustrated in (a) of FIG. 3, the control section 28 of the second terminal 2 causes the display section 23 to display a screen which inquires whether or not to connect to the first terminal 1. In a case where the user touches “OK”, the control section 28 obtains information to that effect from the operation section 24 and causes the display section 23 to display a screen which explains a procedure for establishing pairing, as illustrated in (b) of FIG. 3.

In a case where the user goes on to touch “NEXT”, the control section 28 obtains information to that effect from the operation section 24 and causes the display section 23 to display a screen for inputting a four-digit number, as illustrated in (c) of FIG. 3. In response, the user (i) inputs a four-digit number, which is displayed on the display section 12 of the first terminal 1, to the screen displayed on the display section 23 of the second terminal 2 and (ii) touches “OK”.

In this case, a pairing process is carried out between the first terminal 1 and the second terminal 2. For example, the control section 28 of the second terminal 2 carries out an authentication procedure with the first terminal 1 via the local communication section 22 with use of the number inputted to the screen on the display section 23. At a point in time when the authentication procedure is successfully carried out, the pairing process is ended. Then, data transmission is carried out between the first terminal 1 and the second terminal 2.

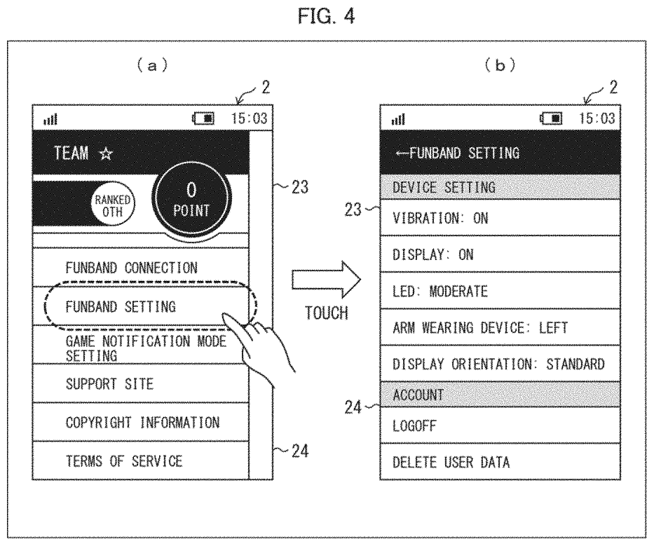

FIG. 4 is views illustrating an operation carried out on a screen of the second terminal 2 in order to change a setting of the bodily sensation notification section 15, the lights 123, or the like of the first terminal 1, in accordance with Embodiment 1. (a) of FIG. 4 illustrates an operation menu screen. (b) of FIG. 4 illustrates a setting screen related to the first terminal 1.

As illustrated in (a) of FIG. 4, the control section 28 of the second terminal 2 causes the display section 23 to display the operation menu screen. In a case where the user touches “Setting of First Terminal 1”, the control section 28 obtains information to that effect from the operation section 24 and causes the display section 23 to display a setting screen of the first terminal 1, as illustrated in (b) of FIG. 4. The user carries out a setting related to the first terminal 1 by touching a corresponding one of items on the setting screen.

In this case, the control section 28 of the second terminal 2 (i) obtains data of the item set by the user and related to the first terminal 1 and (ii) causes the data to be stored in a storage section (not illustrated). The control section 28 transmits the data of the item related to the first terminal 1 to the first terminal 1 via the local communication section 22. The control section 17 of the first terminal (i) receives the data of the item from the second terminal 2 via the communication section 11 and (ii) carries out a setting of each section in accordance with the data of the item.

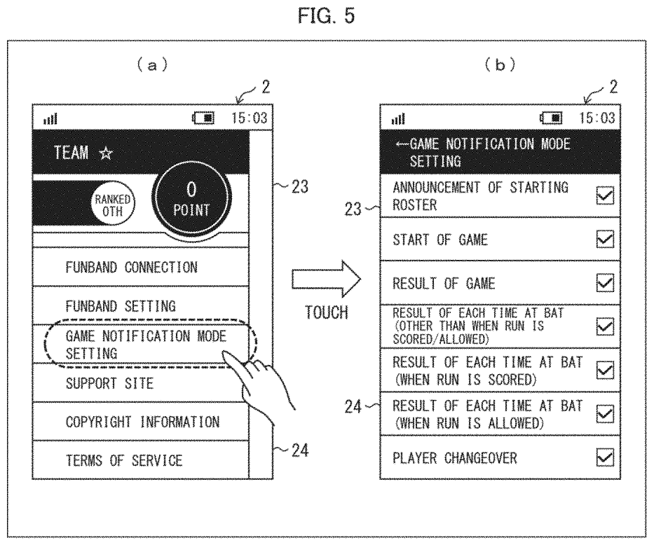

FIG. 5 is views illustrating an operation carried out on a screen of the second terminal 2 in order to change a setting of notification information to be notified to the first terminal 1, in accordance with Embodiment 1. (a) of FIG. 5 illustrates an operation menu screen. (b) of FIG. 5 illustrates a setting screen for notification information to be notified to the first terminal 1.

As illustrated in (a) of FIG. 5, the control section 28 of the second terminal 2 causes the display section 23 to display the operation menu screen. In a case where the user touches “Setting of Game Notification Mode”, the control section 28 obtains information to that effect from the operation section 24 and causes the display section 23 to display a setting screen for a game notification mode, as illustrated in (b) of FIG. 5. The user selects an item of which the user wants to be notified, by ticking a corresponding one of items displayed on the setting screen for the game notification mode.

In this case, the control section 28 of the second terminal 2 (i) obtains data of the item which has been selected by the user and is to be notified to the user in the game notification mode and (ii) causes the data to be stored in the storage section (not illustrated). Then, in a case where the control section 28 has received game information and game progress information from the server 3, the control section 28 (i) refers to the data, which has been stored, of the item to be notified to the user and (ii) filters the game information and the game progress information down to information to be displayed on the display section 23 or to information to be transmitted to the first terminal 1.

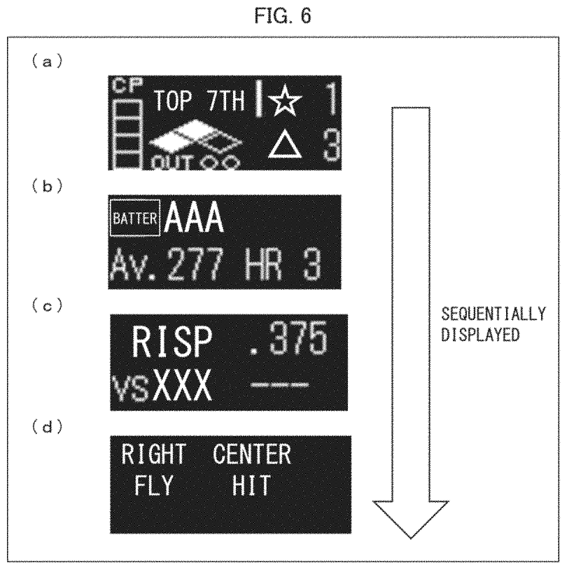

FIG. 6 is views illustrating an example of a state of a baseball game displayed on the display section 12 of the first terminal 1, in accordance with Embodiment 1. As illustrated in (a) of FIG. 6, the control section 17 of the first terminal 1 causes the display section 12 to display a score, an inning, an out count, and bases run or stolen. Subsequently, as illustrated in (b) of FIG. 6, the control section 17 of the first terminal 1 causes the display section 12 to display a name and a performance of a current batter. Subsequently, as illustrated in (c) of FIG. 6, the control section 17 of the first terminal 1 causes the display section 12 to display a name and a performance of a current pitcher. Further, as illustrated in (d) of FIG. 6, the control section 17 of the first terminal 1 causes the display section 12 to display a performance of the current batter against the current pitcher.

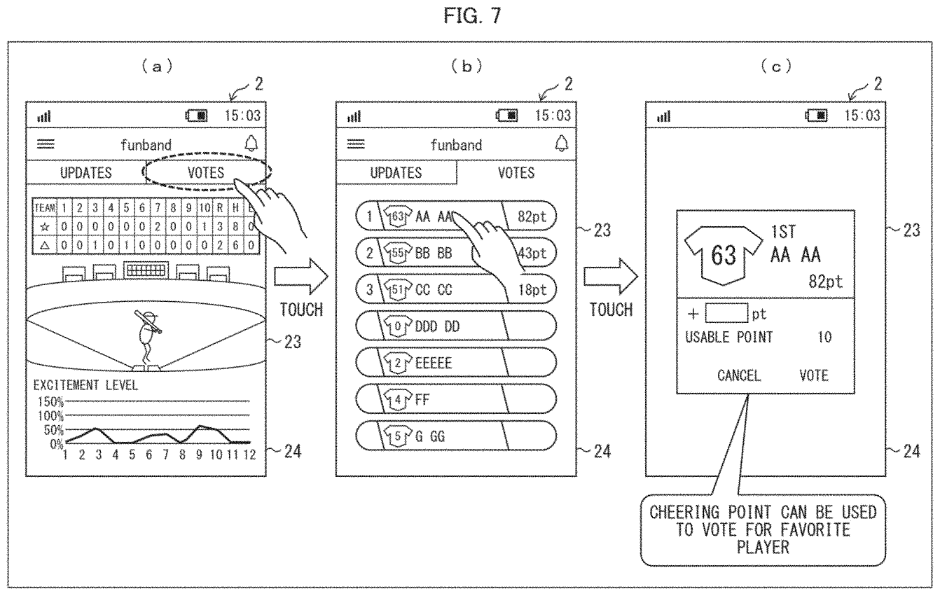

FIG. 7 is views illustrating operation screens of the second terminal 2, which operation screens are related to voting for a player with use of a cheering point, in accordance with Embodiment 1. (a) of FIG. 7 illustrates a screen showing updates. (b) of FIG. 7 illustrates a screen showing a list of players to be voted for. (c) of FIG. 7 illustrates a screen for voting.

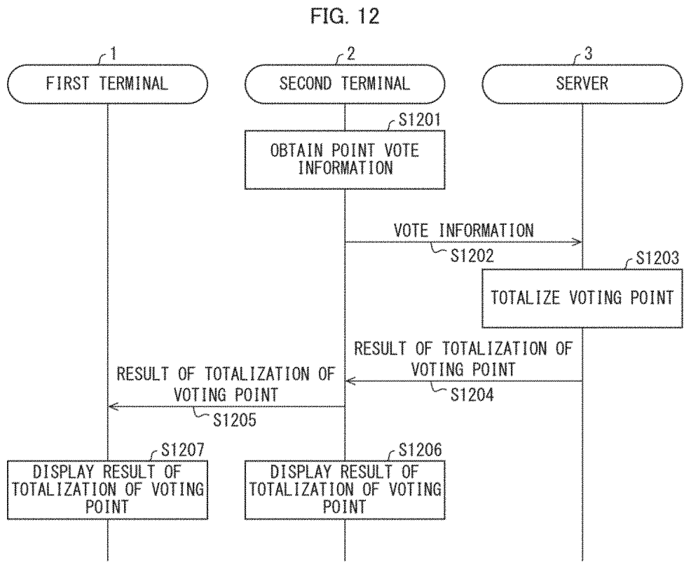

As illustrated in (a) of FIG. 7, the control section 28 of the second terminal 2 causes the display section 23 to display a screen showing updates. In a case where the user touches “VOTES”, the control section 28 obtains information to that effect from the operation section 24 and causes the display section 23 to display a screen showing a list of players, as illustrated in (b) of FIG. 7. In a case where the user touches a name of a player favored by the user, the control section 28 of the second terminal 2 causes the display section 12 to display a uniform number of the player, points currently owned by the player, and the like, as illustrated in (c) of FIG. 7. Then, the user votes for the player with use of remaining cheering points of the user. A subsequent process related to totalization of voting points will be described later with reference to FIG. 12.

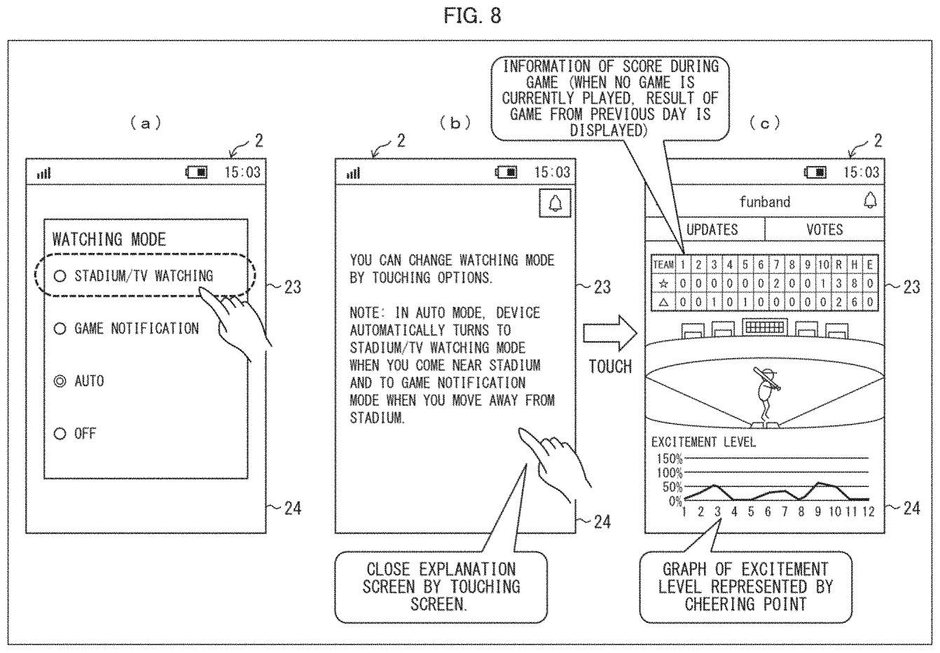

FIG. 8 is views illustrating screens related to a watching mode in accordance with Embodiment 1. (a) of FIG. 8 illustrates a setting screen for the watching mode. (b) of FIG. 8 illustrates a screen explaining the watching mode. (c) of FIG. 8 illustrates a screen showing updates.

As illustrated in (a) of FIG. 8, the control section 28 of the second terminal 2 causes the display section 23 to display a setting screen for the watching mode. The watching mode can be set to a “STADIUM/TV WATCHING” mode, a “GAME NOTIFICATION” mode, an “AUTO” mode, or an “OFF” mode. In a case where the watching mode has been set to “STADIUM/TV WATCHING”, which is a mode for getting excited from real-time game watching at the stadium or through a TV, a radio, or the like, (i) a state of the game is reported and (ii) a behavior of the user associated with cheering by the user contributes to an increase of cheering points. In a case where the watching mode has been set to “GAME NOTIFICATION”, which is a mode for a situation where the user is unable to watch a game, a status of the game is reported but a behavior of the user associated with cheering by the user does not contribute to an increase of cheering points. In a case where the watching mode has been set to “AUTO”, the second terminal 2 turns to the “STADIUM/TV WATCHING” mode when the user comes near a stadium. Further, in the case where the watching mode has been set to “AUTO”, the second terminal 2 turns to the “GAME NOTIFICATION” mode when the user has moved away from the stadium. In a case where the watching mode has been set to “OFF”, pairing between the first terminal 1 and the second terminal 2 is not carried out.

For example, in a case where (i) the watching mode has been set to “AUTO” and (ii) the control section 28 of the second terminal 2 has determined that a current location indicated by the location obtaining section 25 is an inside of a stadium, an inside of a room with a TV at home of the user, or the like location, the control section 28 changes the watching mode to “STADIUM/TV WATCHING”. In a case where the control section 28 of the second terminal 2 has determined that a current location indicated by the location obtaining section 25 is a location other than an inside of a stadium, an inside of a room with a TV at home of the user, or the like location, the control section 28 changes the watching mode to “GAME NOTIFICATION”.

As illustrated in (b) of FIG. 8, the control section 28 of the second terminal 2 causes the display section 23 to display a screen explaining the watching mode.

As illustrated in (c) of FIG. 8, in a case where the user has touched the screen, the control section 28 of the second terminal 2 (i) causes the screen explaining the watching mode to be closed and (ii) causes the display section 23 to display a screen showing updates. The control section 28 causes the display section 23 to display game score information. When no game is currently being played, the control section 28 causes the display section 23 to display a result of a game from the previous day instead of the game score information.

Further, the control section 28 of the second terminal 2 causes the display section 23 to display a graph of an excitement level represented by cheering points. In this case, for example, the second terminal 2 (i) obtains, from the server 3, a total value of cheering points that were given, during a predetermined time zone (e.g., during each inning), by users who support the same team as the user and (ii) plots, for each time zone and on the graph on the screen, a ratio of the total value to a predetermined value.

Configuration of Totalizing System 100

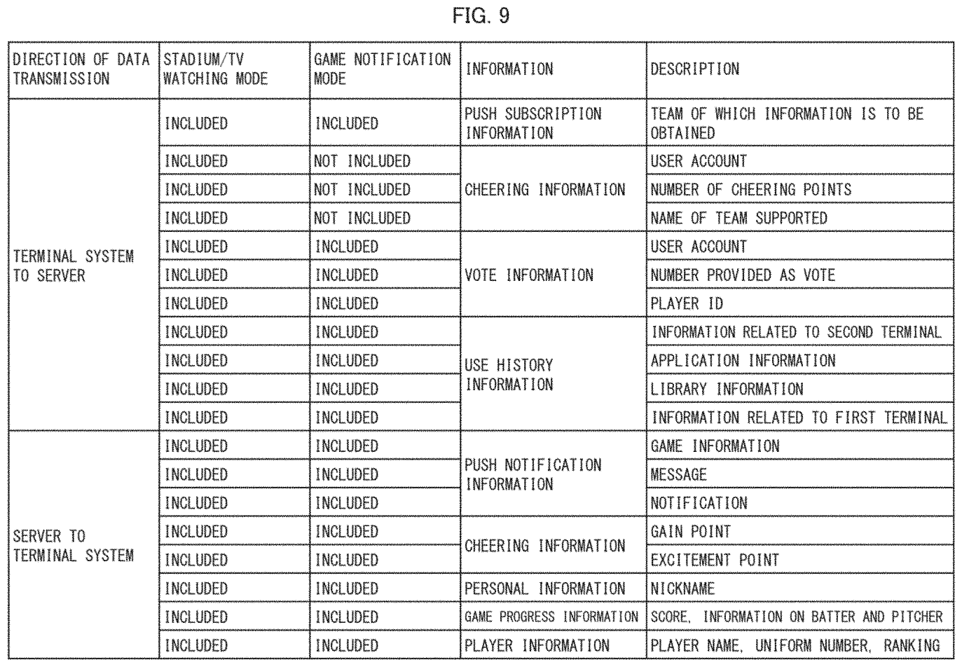

FIG. 9 is a table illustrating information transmitted between each of the one or more terminal systems 10 and the server 3 in accordance with the watching mode, in accordance with Embodiment 1. The each of the one or more terminal systems 10 carries out filtering of information to be transmitted to the server 3, in accordance with the watching mode.

As illustrated in FIG. 9, information transmitted from the each of the one or more terminal systems 10 to the server 3 includes Push subscription information, cheering information, vote information, and use history information. The Push subscription information includes name of a team of which the user wants to obtain information. The cheering information includes user account, the number of cheering points, and name of a team which the user supports. The number of cheering points is (i) the number of times the user has shaken the first terminal 1 or (ii) a value linked to the number. The vote information includes user account, number provided as a vote, and player ID. The number provided as a vote is a number that is provided by the user as a vote for a specified player.

The user history information includes information related to the second terminal 2, application information, library information, and information related to the first terminal 1. The information related to the second terminal 2 is device name, OS version, terminal setting, and the like. The application information is application which has been set, operation history, history of visiting a stadium, and the like. The library information is connection history, Push reception history, and the like. The information related to the first terminal 1 is firmware version, Bluetooth address, expiration date, and the like.

In a case where the watching mode has been set to the “STADIUM/TV” mode, the each of the one or more terminal systems 10 transmits the Push subscription information, the cheering information, the vote information, and the user history information to the server 3. In a case where the watching mode is set to the “GAME NOTIFICATION” mode, the each of the one or more terminal systems 10 transmits to the server 3 the same set of information excluding the cheering information, namely, the Push subscription information, the vote information, and the user history information.

As illustrated in FIG. 9, information transmitted from the server 3 to the each of the one or more terminal systems includes Push notification information, cheering information, personal information, game progress information, and player information. The Push notification information includes game information, message, and notification. Both in a case where the watching mode has been set to the “STADIUM/TV” mode and in a case where the watching mode has been set to the “GAME NOTIFICATION” mode, the each of the one or more terminal systems 10 receives game information and a message and then filters the game information and the message with use of an application on the second terminal 2. The game information is information (e.g., names of teams having a game together, name of a stadium, name of a starting pitcher, information of a starting roster, end of inning, game result, or the like) related to a state of the game which state is likely to cause excitement. The message is a cheering message or the like. The notification is a notification directed to a user who is using the application.

The cheering information includes gain point and excitement point. The gain point is today's point, today's ranking, yearly point, yearly ranking, or the like. The excitement point is information indicative of an excitement level of the game during, for example, every 5 minutes or every inning. Specifically, the excitement point is a total value of cheering points that were given, during a predetermined time zone, by users who support the same team as the user.

The personal information includes nickname. The game progress information includes, as information related to a progress of the game, (i) information as of a start of the game, (ii) a result of each time at bat, (iii) base running and pickoff information, (iv) information on running to a scoring position, (v) player changeover, (vi) score, and (vii) information on a current batter and a current pitcher. The player information includes player name, uniform number, and ranking.

Both in a case where the watching mode is set to the “STADIUM/TV” mode and in a case where the watching mode is set to the “GAME NOTIFICATION” mode, the server 3 transmits the Push notification information, the cheering information, the personal information, the game progress information, and the player information to the terminal system 10.

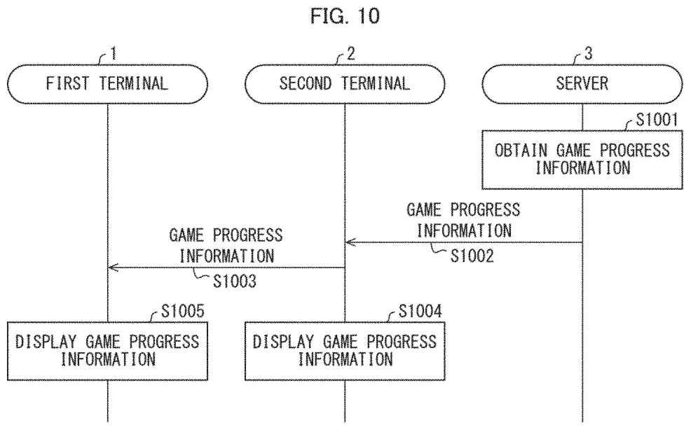

FIG. 10 is a sequence chart illustrating a process which is related to game progress information and carried out by the totalizing system 100 in accordance with Embodiment 1. The server 3 (i) delivers game progress information to a plurality of first terminals 1 via the second terminal 2 or (ii) delivers game progress information directly to the plurality of first terminals 1 without involving the second terminal 2.

Step S1001

The information server 4 transmits game progress information to the server 3 every time a result of a single time at bat is fixed. The server 3 obtains the game progress information from the information server 4.

Step S1002

The server 3 (i) extracts, from the game progress information obtained from the information server 4, game progress information related to a team of which the user has been obtaining information or a team supported by the user and (ii) transmits the game progress information thus extracted to the second terminal 2 of the user. Note that the server 3 may transmit the game progress information to a corresponding first terminal 1 instead of to the second terminal 2. The second terminal 2 receives the game progress information from the server 3.

Step S1003

The second terminal 2 transmits to the first terminal 1 the game progress information received from the server 3. The first terminal 1 receives the game progress information from the second terminal 2. Note that the first terminal 1 may receive the game progress information from the server 3 instead of from the second terminal 2.

Step S1004

The second terminal 2 displays the game progress information received from the server 3. For example, as illustrated in (a) of FIG. 7, the control section 28 of the second terminal 2 causes the display section 23 to display a screen showing updates related to a progress of the game.

Step S1005

The first terminal 1 displays the game progress information received from the second terminal 2. For example, as illustrated in FIG. 6, the control section 17 of the first terminal 1 causes the display section 12 to display a state of the game. In this case, in addition to displaying the state of the game, the control section 17 of the first terminal 1 may (i) light up or blink the lights 123 or (ii) cause the bodily sensation notification section 15 to, for example, vibrate for a predetermined time.

The user can check the state of the game, upon seeing the lights light up or blink or upon feeling a bodily sensation resulting from vibration of the bodily sensation notification section 15 or the like.

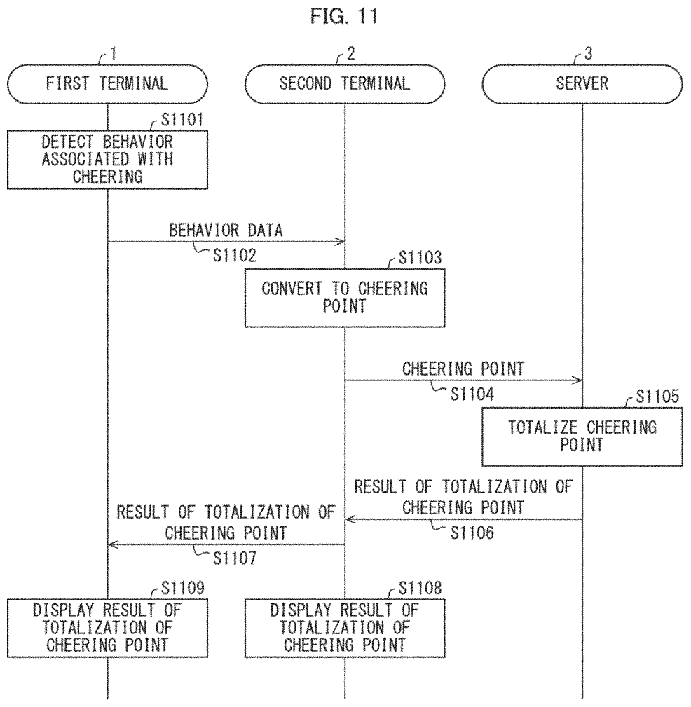

FIG. 11 is a sequence chart illustrating a process which is related to totalization of points and carried out by the totalizing system 100 in accordance with Embodiment 1. The process is a process of (i) representing, as points, a behavior of the user associated with cheering by the user and (ii) totalizing the points.

Step S1101

The first terminal 1 detects a behavior (motion, sound, utterance, or the like) of the user associated with cheering by the user. In this case, the control section 17 of the first terminal 1 may (i) light up or blink the lights 123 or (ii) cause the bodily sensation notification section 15 to, for example, vibrate for a predetermined time. This allows the user to receive a feedback to the cheering carried out by the user.

Step S1102

The first terminal 1 prepares behavior data in accordance with the behavior which has been detected, and transmits the behavior data to the second terminal 2. For example, the control section 17 of the first terminal 1 prepares behavior data which includes (i) the number of times the user shook the first terminal 1, (ii) the number of times the user provided an utterance, (iii) time, and (iv) the like. The second terminal 2 receives the behavior data from the first terminal 1.

Step S1103

In a case where the watching mode has been set to “STADIUM/TV WATCHING”, the second terminal 2 converts the behavior data received from the first terminal 1 into a cheering point. For example, the control section 28 of the second terminal 2 may convert the number of times the user shook the first terminal 1 directly into the number of cheering points, or may convert a result of calculation, in which the number is subjected to addition, subtraction, multiplication, and/or division with use of a predetermined value, into the number of cheering points, or may carry out other conversions.

Step S1104

The second terminal 2 transmits to the server 3 the cheering point thus converted. The server 3 receives the cheering point from the second terminal 2.

Step S1105

The server 3 carries out totalization of cheering points by adding the cheering points received from the second terminal 2 to a cumulative total value of cheering points of the user. The cumulative total value of the cheering points may be the number of cheering points from each day, each week, each month, or each year.

Step S1106

The server 3 transmits a result of the totalization of the cheering points of the user to the second terminal 2 of the user. Note that the server 3 may transmit the result of the totalization of the cheering points to the first terminal 1 instead of to the second terminal 2. The second terminal 2 receives the result of the totalization of the cheering points from the server 3.

Step S1107

The second terminal 2 transmits to the first terminal 1 the result of the totalization of the cheering points received from the server 3. The first terminal 1 receives the result of the totalization of the cheering points from the second terminal 2. Note that the first terminal 1 may receive the result of the totalization of the cheering points from the server 3 instead of from the second terminal 2.

Step S1108

The second terminal 2 displays the result of the totalization of the cheering points received from the server 3.

Step S1109 The first terminal 1 displays the result of the totalization of the cheering points received from the second terminal 2.

FIG. 12 is a sequence chart illustrating a process which is related to totalization of voting points and carried out by the totalizing system 100 in accordance with Embodiment 1. The process is a process of (i) converting cheering points to voting points related to popularity voting and (ii) totalizing the voting points.

Step S1201

The user votes for a player favored by the user with use of a cheering point on a screen of the second terminal 2 as illustrated in FIG. 7. Note that cheering points may be converted to voting points such that a certain number of cheering points are converted into the same number of voting points (a conversion rate=1:1) or such that cheering points are converted by a predetermined conversion rate (a rate other than 1:1). Further, a cumulative total value of cheering points of the user may be converted into a virtual currency so that the user votes for the player favored by the user with use of the virtual currency.

The second terminal 2 obtains vote information including voting points for a specific player.

Step S1202

The second terminal 2 transmits to the server 3 the vote information obtained from the screen. The server 3 receives the vote information from the second terminal 2.

Step S1203

The server 3 carries out totalization of voting points by (i) extracting, from the vote information received from the second terminal 2, the voting points for the specific player and (ii) adding the voting points thus extracted to a cumulative total value of voting points of the specific player. The cumulative total value of the voting points may be the number of voting points from each game, each week, each month, or each season.

Step S1204

The server 3 transmits a result of the totalization of the voting points of the player to the second terminal 2 of the user. Note that the server 3 may transmit the result of the totalization of the voting points to the first terminal 1 instead of to the second terminal 2. The second terminal 2 receives the result of the totalization of the voting points from the server 3.

Step S1205

The second terminal 2 transmits to the first terminal 1 the result of the totalization of the voting points received from the server 3. The first terminal 1 receives the result of the totalization of the voting points from the second terminal 2. Note that the first terminal 1 may receive the result of the totalization of the voting points from the server 3 instead of from the second terminal 2.

Step S1206

The second terminal 2 displays the result of the totalization of the voting points received from the server 3.

Step S1207

The first terminal 1 displays the result of the totalization of the voting points received from the second terminal 2.

As described above, the totalizing system 100 in accordance with Embodiment 1 is configured such that the each of the one or more terminal systems 10 includes: the mobile network communication section 21; the control section 28; the display section 12; and the behavior detecting section 16, the behavior detecting section 16 being configured to detect a behavior of a user, the behavior including at least one of motion and utterance, the control section 28 being configured to: determine which one of a plurality of modes is currently set; calculate a cheering point with reference to behavior data in a case where the control section 28 has determined that a specific mode is currently set, the behavior data being indicative of the behavior detected by the behavior detecting section 16; transmit, via the mobile network communication section 21, the cheering point which has been calculated; and cause the display section 12 to display totalization information obtained via the mobile network communication section 21, the totalization information being indicative of a total of a cheering point, the server 3 including: a communication section 31; and a control section 32, the control section 32 being configured to: make a totalization of a cheering point obtained via the communication section 31; and transmit, via the communication section 31, totalization information indicative of a result of the totalization. This allows the totalizing system 100 to make a response that (i) increases a user's motivation to cheer for an event and (ii) motivates the user to visit an event site or the like to cheer.

Further, the totalizing system 100 in accordance with Embodiment 1 is configured such that the each of the one or more terminal systems 10 further includes a bodily sensation notification section 15, the control section 17 being configured to cause the bodily sensation notification section 15 to vibrate in accordance with a mode which is currently set. This allows the totalizing system 100 to cause a user to feel a bodily sensation notifying excitement.

Further, the totalizing system 100 in accordance with Embodiment 1 is configured such that the one or more servers include a first server and a second server, the first server being configured to process information obtained from the second server and transmit, to the one or more terminal systems 10, the information which has been processed. This allows the terminal systems 10 to present information processed by the one or more servers.

Further, the totalizing system 100 in accordance with Embodiment 1 is configured such that any one of the one or more terminal systems includes the first terminal 1 and the second terminal 2, the first terminal 1 including: the communication section 11 configured to communicate with the second terminal 2; the control section 17; the display section 12; and the behavior detecting section 16, the control section 17 being configured to: obtain the totalization information from the second terminal 2 via the communication section 11; and cause the display section 12 to present the totalization information which has been obtained, the second terminal 2 including: the local communication section 22 configured to communicate with the first terminal 1; the control section 28; and the mobile network communication section 21, the control section 28 being configured to: obtain the totalization information from the server 3 via the mobile network communication section 21; and transmit, to the first terminal 1 via the local communication section 22, the totalization information which has been obtained. This allows the first terminal 1 to present totalization information obtained via the second terminal 2.

Further, the totalizing system 100 in accordance with Embodiment 1 is configured such that any one of the one or more terminal systems 10 includes a single first terminal 1. This allows the single first terminal to present totalization information obtained from the one or more servers.

Further, the totalizing system 100 in accordance with Embodiment 1 is configured such that the control section 17 is configured to cause the display section 12 to present game progress information obtained via the communication section 11; and the control section 32 is configured to: extract, from game progress information obtained via the communication section 31, game progress information related to a specific game; and transmit, via the communication section 31, the game progress information which has been extracted. This allows the each of the one or more terminal systems 10 to present game progress information obtained from the one or more servers 3.

Further, the totalizing system 100 in accordance with Embodiment 1 is configured such that: the control section 28 is configured to: obtain vote information indicative of a number provided by a user as a vote; transmit, via the mobile network communication section 21, the vote information which has been obtained; and cause the display section 23 to present a result of totalization of a vote, which result has been obtained via the mobile network communication section 21; and the control section 32 is configured to: make a totalization of vote information obtained via the communication section 31; and transmit, via the communication section 31, vote totalization information indicative of a result of the totalization. This allows the each of the one or more terminal systems 10 to present vote totalization information obtained from the one or more servers 3.

### Embodiment 2

The following description will discuss in detail Embodiment 2 of the present invention. The totalizing system 100 in accordance with Embodiment 1 of the present invention illustrated in FIG. 1 has a single information server 4. In contrast, a totalizing system 101 in accordance with Embodiment 2 includes a plurality of information servers (other servers) 4 and 5. The information servers 4 and 5 each provide to the server 3 information which is in accordance with a specific event type. “Event type” indicates a type of an event, such as baseball game watching, an event of a fan club of a musician, and a participatory sport event. For baseball game watching or the like, the “event type” includes information that identifies a team supported by a user. Note that the number of the information servers is not limited to two, and may be any number greater than one (1).

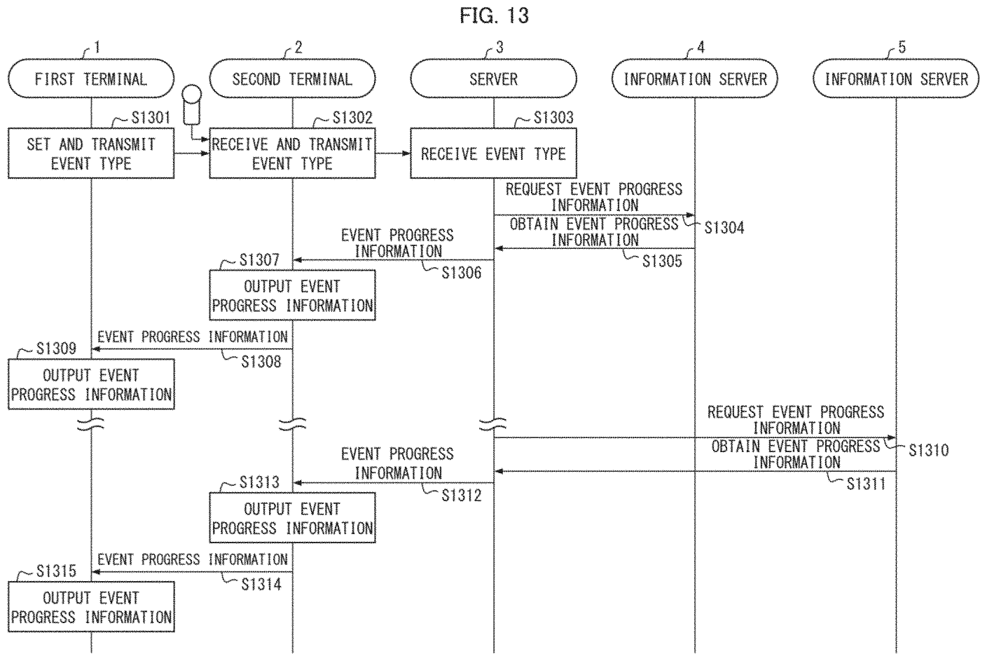

FIG. 13 is a sequence chart illustrating a process which is related to event progress information and carried out by the totalizing system 101 in accordance with Embodiment 2.

Step S1301

The user sets an event type with use of the first terminal 1. In this case, the first terminal 1 may cause a display section 12 to display options for the event type so that the user can select any one of the options with use of an operation section 13. Further, the first terminal 1 may cause event type information, which indicates an event type specific to the first terminal 1, to be stored in advance in a storage section (not illustrated) of the first terminal 1 or in a storage medium (not illustrated), such as a memory card, that can be accessed by the first terminal 1. Further, the first terminal 1 may cause the event type information to be stored in the storage section or the storage medium such that the event type information is associated with an ID unique to the first terminal 1. In order to select another event type, the user may use another first terminal 1 or another storage medium corresponding to the another event type.

A control section 17 of the first terminal 1 obtains the event type information from the operation section 13, the storage section, or the storage medium and transmits the event type information to a second terminal 2 via a communication section 11.

Step S1302

A control section 28 of the second terminal 2 receives the event type information from the first terminal 1 via a local communication section 22. Then, the control section 28 transmits the event type information to a server 3 via a mobile network communication section 21.

Note that instead of the process of the step S1301, a process can be carried out in which the control section 28 of the second terminal 2 sets event type information in accordance with an input given by the user with use of an operation section 24. Further, the control section 28 may (i) store therein event type information received from the first terminal 1 and (ii) use the event type information which has been stored, instead of newly receiving event type information in a second occasion or after. Further, an application to be run by the control section 28 may be provided for each event type, and the control section 28 may store therein event type information specific to each application. In such a case, in order to select another event, the user uses another application corresponding to the another event.

Step S1303

A control section 32 of the server 3 receives event type information from the second terminal 2 via a communication section 31. The control section 32 causes a combination of (i) identification information of the first terminal 1, (ii) identification information of the second terminal 2 with which the first terminal 1 is paired, and (iii) an event type, to be stored in a database (not illustrated) so that the control section 32 carries out a process by using information indicative of the combination. The control section 32 changes a subsequent process depending on the event type information which has been received.

Step S1304

The control section 32 of the server 3 requests the information server 4 for event progress information via the communication section 31. The control section 32 identifies, in accordance with the event type, an information server to which a request for the event progress information is to be made. The information server 4 receives the request for the event progress information from the server 3.

Step S1305

In response to the request from the server 3, the information server 4 transmits the event progress information to the server 3. The server 3 obtains the event progress information from the information server 4.

For example, in a case where the information of the team supported by the user, which information is included in the event type information, indicates a team A, the server 3 requests the information server 4, which corresponds to the team A, for event progress information. In a case where a team B is indicated by the information of the team supported by the user, the server 3 accesses the information server 5, which corresponds to the team B.

Note, however, that the above requests do not have to be made to physically different information servers. The server 3 may simply change URL to be accessed such that, for example, the server 3 accesses “http://sample.com/yakyuu/team-a.html” for the team A and access “http://sample.com/yakyuu/team-b.html” for the team B.

Step S1306

The server 3 transmits, to the second terminal 2 of the user, the event progress information obtained from the information server 4. The second terminal 2 receives the event progress information from the server 3.

Step S1307

The second terminal 2 outputs the event progress information received from the server 3.

Step S1308

The second terminal 2 transmits to the first terminal 1 the event progress information received from the server 3. The first terminal 1 receives the event progress information from the second terminal 2.

Step S1309

The first terminal 1 outputs the event progress information received from the second terminal 2.

Step S1310

In a case where the event type has been changed, the server 3 requests the information server 5, not the information server 4, for event progress information.

Note that processes carried out at steps S1311 through S1315 are similar to those of the steps S1305 through S1309.

According to the above-described process, various information (e.g., game progress information of the team A, game progress information of the team B, event progress information of a music group C, or the like) is delivered depending on an event type inputted to the first terminal 1 or an event type specific to the first terminal 1. This allows a single first terminal 1 to be utilized for purposes related to a plurality of events.

As described above, the totalizing system 101 in accordance with Embodiment 2 is configured such that: the control section 17 is configured to: transmit, via the communication section 11, event type information indicative of event type; and cause the display section 12 to present event progress information obtained via the communication section 11; and the control section 32 is configured to: obtain the event type information via the communication section 31; obtain event progress information from another information server corresponding to the event type information which has been obtained; and transmit, via the communication section 31, the event progress information which has been obtained. This allows the terminal system 10 to present event progress information corresponding to an event type obtained from the server 3.

### Embodiment 3

In the foregoing embodiments, examples have been described in each of which one (1) server 3 is used. Note, however, that the functions of the server 3 can be achieved by separate servers. In a case of employing a plurality of servers, the plurality of servers may be managed by an identical business operator or may be managed by respective different business operators.

### Embodiment 4

Control blocks of each of the terminal system 10 and the server 3 can be realized by a logic circuit (hardware) provided in an integrated circuit (IC chip) or the like or can be alternatively realized by software. In the latter case, it is possible to configure each of the terminal system 10 and the server 3 with use of a computer as illustrated in FIG. 13.

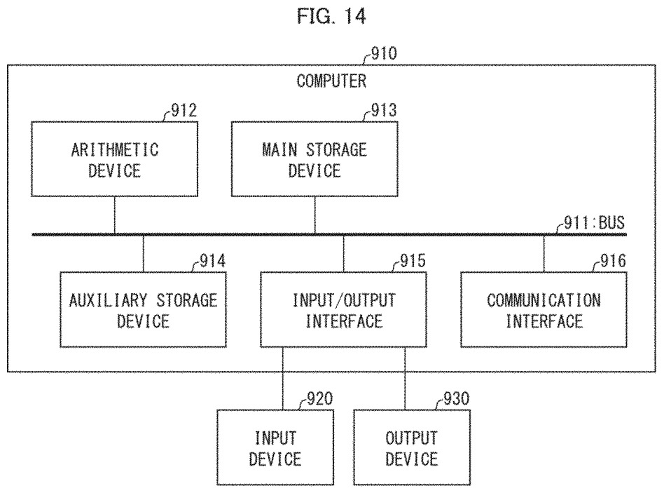

FIG. 14 is a block diagram illustrating an example configuration of a computer 910 that can be used as the terminal system 10 or the server 3. The computer 910 includes an arithmetic device 912, a main storage device 913, an auxiliary storage device 914, an input/output interface 915, and a communication interface 916 which are connected to each other via a bus 911. The arithmetic device 912, the main storage device 913, and the auxiliary storage device 914 can be, for example, one or more processors (e.g., a central processing unit: CPU), a random access memory (RAM), and a storage device (e.g., a hard disk drive, a flash memory, or the like), respectively. The input/output interface 915 is connected with (i) an input device 920 with which a user inputs various information to the computer 910 and (ii) an output device 930 via which the computer 910 outputs various information to the user. The input device 920 and the output device 930 can be incorporated into the computer 910 or can be devices which are (externally) connected to the computer 910. For example, the input device 920 can be a keyboard, a mouse, a touch sensor, or the like, and the output device 930 can be a display, a printer, a speaker, or the like. Alternatively, it is possible to employ a device having functions of both the input device 920 and the output device 930, such as a touch panel in which a touch sensor and a display are integrated. The communication interface 916 is an interface via which the computer 910 communicates with an external device.

The auxiliary storage device 914 stores various programs for causing the computer 910 to function as the terminal system 10 and the server 3. The arithmetic device 912 loads, on the main storage device 913, the various programs stored in the auxiliary storage device 914 and executes a command included in each of the various programs so that the computer 910 functions as each section of the terminal system 10 and the server 3. Note that a storage medium which is included in the auxiliary storage device 914 for recording information such as the various programs only needs to be a computer-readable “non-transitory tangible medium” and can be, for example, a tape, a disk, a card, a semiconductor memory, a programmable logic circuit, or the like. The main storage device 913 can be omitted in a computer that can execute the program stored in the storage medium without loading the program on the main storage device 913. The number of each of the above devices (i.e., the arithmetic device 912, the main storage device 913, the auxiliary storage device 914, the input/output interface 915, the communication interface 916, the input device 920, and the output device 930) can be one or can be two or more.

The various programs can be obtained from outside of the computer 910. In this case, the various programs can be obtained via any transmission medium (such as a communication network or a broadcast wave). The present invention can also be achieved in the form of a computer data signal in which the various programs are embodied via electronic transmission and which is embedded in a carrier wave.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

100, 101: totalizing system
10: terminal system
1: first terminal (first terminal device)
2: second terminal (second terminal device)
3: server (first server)
4, 5: information server (second server, another server)
11: communication section (first terminal communication section)
12: display section (information presenting section, first information presenting section)
15: bodily sensation notification section
16: behavior detecting section
17: control section (terminal control section, first terminal control section)
21: mobile network communication section (terminal communication section)
22: local communication section (second terminal communication section)
23: display section (information presenting section)
28: control section (terminal control section, second terminal control section)

1. A totalizing system, comprising:
one or more servers; and
one or more terminal systems,
each of the one or more terminal systems including:
a terminal communication section;
a terminal control section;
an information presenting section; and
a behavior detecting section,
the behavior detecting section being configured to detect a behavior of a user, the behavior including at least one of motion and utterance,
the terminal control section being configured to:
determine which one of a plurality of modes is currently set;
calculate a cheering point with reference to behavior data in a case where the terminal control section has determined that a specific mode is currently set, the behavior data being indicative of the behavior detected by the behavior detecting section;
transmit, via the terminal communication section, the cheering point which has been calculated; and
cause the information presenting section to present totalization information obtained via the terminal communication section, the totalization information being indicative of a total of a cheering point,
each of the one or more servers including:
a server communication section; and
a server control section,
the server control section being configured to:
make a totalization of a cheering point obtained via the server communication section; and
transmit, via the server communication section, totalization information indicative of a result of the totalization.

2. The totalizing system as set forth in claim 1, wherein the each of the one or more terminal systems further includes a bodily sensation notification section,
the terminal control section being configured to cause the bodily sensation notification section to vibrate in accordance with a mode which is currently set.

3. The totalizing system as set forth in claim 1, wherein the one or more servers include a first server and a second server,
the first server being configured to process information obtained from the second server and transmit, to the one or more terminal systems, the information which has been processed.

4. The totalizing system as set forth in claim 1, wherein any one of the one or more terminal systems includes a first terminal device and a second terminal device,
the first terminal device including:
a first terminal communication section configured to communicate with the second terminal device;
a first terminal control section provided as part of the terminal control section;
a first information presenting section provided as part of the information presenting section; and
the behavior detecting section,
the first terminal control section being configured to:
obtain the totalization information from the second terminal device via the first terminal communication section; and
cause the first information presenting section to present the totalization information which has been obtained,
the second terminal device including:
a second terminal communication section configured to communicate with the first terminal device;
a second terminal control section provided as part of the terminal control section; and
the terminal communication section,
the second terminal control section being configured to:
obtain the totalization information from the each of the one or more servers via the terminal communication section; and
transmit, to the first terminal device via the second terminal communication section, the totalization information which has been obtained.

5. The totalizing system as set forth in claim 1, wherein any one of the one or more terminal systems includes a single terminal device.

6. The totalizing system as set forth in claim 1, wherein:
the terminal control section is configured to cause the information presenting section to present event progress information obtained via the terminal communication section; and
the server control section is configured to:
extract, from event progress information obtained via the server communication section, event progress information related to a specific game; and
transmit, via the server communication section, the event progress information which has been extracted.

7. The totalizing system as set forth in claim 1, wherein:
the terminal control section is configured to:
obtain vote information indicative of a number provided by a user as a vote;
transmit, via the terminal communication section, the vote information which has been obtained; and
cause the information presenting section to present a result of totalization of a vote, which result has been obtained via the terminal communication section; and
the server control section is configured to:
make a totalization of vote information obtained via the server communication section; and
transmit, via the server communication section, vote totalization information indicative of a result of the totalization.

8. The totalizing system as set forth in claim 1, wherein:
the terminal control section is configured to:
transmit, via the terminal communication section, event type information indicative of event type; and
cause the information presenting section to present event progress information obtained via the terminal communication section; and
the server control section is configured to:
obtain the event type information via the server communication section;
obtain event progress information from another server corresponding to the event type information which has been obtained; and
transmit, via the server communication section, the event progress information which has been obtained.

9. A terminal system which communicates with one or more servers, comprising:
a terminal communication section;
a terminal control section;
an information presenting section; and
a behavior detecting section,
the behavior detecting section being configured to detect a behavior of a user, the behavior including at least one of motion and utterance,
the terminal control section being configured to:
determine which one of a plurality of modes is currently set;
calculate a cheering point with reference to behavior data in a case where the terminal control section has determined that a specific mode is currently set, the behavior data being indicative of the behavior detected by the behavior detecting section;
transmit, via the terminal communication section, the cheering point which has been obtained; and
cause the information presenting section to present totalization information obtained via the terminal communication section.

10. A terminal system as set forth in claim 9, further comprising:
a first terminal device; and
a second terminal device,
the first terminal device including:
a first terminal communication section configured to communicate with the second terminal device;
a first terminal control section provided as part of the terminal control section;
a first information presenting section provided as part of the information presenting section; and
the behavior detecting section,
the first terminal control section being configured to:
obtain the totalization information from the second terminal device via the first terminal communication section; and
cause the first information presenting section to present the totalization information which has been obtained,
the second terminal device including:
a second terminal communication section configured to communicate with the first terminal device;
a second terminal control section provided as part of the terminal control section; and
the terminal communication section,
the second terminal control section being configured to:
obtain the totalization information from the server via the terminal communication section; and
transmit, to the first terminal device via the second terminal communication section, the totalization information which has been obtained.

11. A server which communicates with one or more terminal systems, comprising:
a server communication section; and
a server control section,
the server control section being configured to:
make a totalization of a cheering point obtained from the one or more terminal systems via the server communication section; and
transmit, to the one or more terminal systems via the server communication section, totalization information indicative of a result of the totalization.

12. A computer-readable non-transitory recording medium on which a program for causing a computer to function as a terminal device is stored,
the program causing the computer to:
determine which one of a plurality of modes is currently set; and
calculate a cheering point with reference to behavior data in a case where the computer has determined that a specific mode is currently set, the behavior data being indicative of a behavior which has been detected.

13. A totalizing method carried out by a totalizing system,
said totalizing system including:
one or more servers; and
one or more terminal systems,
said totalizing method comprising the steps of:
(a) the one or more terminal systems detecting a behavior of a user, the behavior including at least one of motion and utterance;
(b) the one or more terminal systems determining which one of a plurality of modes is currently set;
(c) the one or more terminal systems calculating a cheering point with reference to behavior data in a case where the one or more terminal systems have determined that a specific mode is currently set, the behavior data being indicative of the behavior which has been detected;
(d) the one or more terminal systems transmitting the cheering point which has been calculated;
(e) the one or more terminal systems presenting totalization information which has been obtained, the totalization information being indicative of a total of a cheering point;
(f) the one or more servers making a totalization of a cheering point obtained via a server communication section; and
(g) the one or more servers transmitting totalization information indicative of a result of the totalization.
